(19) United States
(12) Patent Application Publication
(10) Pub. No.: US 2026/0356234 A1
(43) Pub. Date: Nov. 12, 2026

(54) INFORMATION PROCESSING DEVICE, INFORMATION PROCESSING METHOD, AND PROGRAM

(71) Applicant: Sony Group Corporation, Tokyo (JP)

(72) Inventors: Yasuyuki KATO, Tokyo (JP); Yuhei YABE, Tokyo (JP); Mizue ADACHI, Tokyo (JP); Yutaka MURAKAMI, Tokyo (JP); Takayuki KAWAI, Tokyo (JP); Yasufumi OGAWA, Tokyo (JP); Kentaro NAKAMURA, Kanagawa (JP); Takuma DOMAE, Tokyo (JP)

(73) Assignee: Sony Group Corporation, Tokyo (JP)

(21) Appl. No.: 19/515,498

(22) PCT Filed: Sep. 10, 2024
(86) PCT No.: PCT/JP2024/032304

§ 371 Date: Mar. 2, 2026

(30) Foreign Application Priority Data
Sep. 29, 2023 (JP) 2023-169842

(51) Int. Cl. B60L 53/66; G06Q 30/0201

(52) U.S. Cl. CPC B60L 53/665; G06Q 30/0206

(57) ABSTRACT

The present technology relates to an information processing device, an information processing method, and a program, which can provide a new mechanism regarding a method of bearing the cost of a battery of a mobile body. An information processing device of the present technology includes a calculation unit that calculates a battery usage fee that is a usage fee for a battery that is mounted on a mobile body and supplies electric power for movement of the mobile body, based on a charge amount or a discharge amount of the battery, and an information generation unit that generates billing amount information including information regarding the battery usage fee. The present technology can be applied to, for example, a server of an operator engaged on business related to a battery of an electric vehicle.

### TECHNICAL FIELD

The present technology relates to an information processing device, an information processing method, and a program, and particularly relates to an information processing device, an information processing method, and a program that are applicable to a business model using a battery of a mobile body.

### BACKGROUND ART

In the related art, in order to reduce a financial burden on users when purchasing a new car, a system has been proposed that estimates a used car price after N years and sets a loan amount based on a price obtained by subtracting the estimated price (for example, see PTL 1).

### CITATION LIST

### Patent Literature

PTL 1: JP 2019-16171 A

### SUMMARY

### Technical Problem

In contrast, for electric vehicles (EVs) which have been increasingly used in recent years, a battery is expensive and imposes a substantial financial burden on users.

On the other hand, EV batteries are expected to be used for other applications such as stationary batteries even after a vehicle body has reached the end of its service life. Thus, the monetary value of EV batteries is expected to decrease at a slower rate compared to the vehicle body.

Taking these into consideration, in order to reduce the financial burden on users for purchasing EVs, a new mechanism regarding a method of bearing the cost of EV batteries is desired.

The present technology has been made in view of such circumstances and is intended to provide a new mechanism regarding a method of bearing the cost of batteries of mobile bodies, such as EVs, that travel using electric power of the battery.

### Solution to Problem

An information processing device according to an aspect of the present technology includes a calculation unit that calculates a battery usage fee that is a usage fee for a battery that is mounted on a mobile body and supplies electric power for movement of the mobile body, based on a charge amount or a discharge amount of the battery, and an information generation unit that generates billing amount information including information regarding the battery usage fee.

In an information processing method according to an aspect of the present technology, an information processing device calculates a battery usage fee that is a usage fee for a battery that is mounted on a mobile body and supplies electric power for movement of the mobile body, based on a charge amount or a discharge amount of the battery, and generates billing amount information including information regarding the battery usage fee.

A program according to an aspect of the present technology causes a computer to execute processing of calculating a battery usage fee that is a usage fee for a battery that is mounted on a mobile body and supplies electric power for movement of the mobile body, based on a charge amount or a discharge amount of the battery, and generating billing amount information including information regarding the battery usage fee.

According to an aspect of the present technology, the battery usage fee that is the usage fee for the battery that is mounted on the mobile body and supplies electric power for movement of the mobile body is calculated based on the charge amount or the discharge amount of the battery, and billing amount information including information regarding the battery usage fee is generated.

### BRIEF DESCRIPTION OF DRAWINGS

FIG. 1 is a diagram illustrating an overview of a business model to which the present technology is applied.

FIG. 2 is a graph showing a relationship between a travel distance of a vehicle and a cost of the vehicle.

FIG. 3 is a block diagram illustrating a configuration example of an information processing system to which the present technology is applied.

FIG. 4 is a block diagram illustrating a configuration example of a vehicle.

FIG. 5 is a block diagram illustrating a configuration example of a battery operation server.

FIG. 6 is a flowchart for describing billing amount notification processing.

FIG. 7 is a block diagram illustrating a configuration example of a computer.

### DESCRIPTION OF EMBODIMENTS

Hereinafter, embodiments for implementing the present technology will be described. Description will be made in the following order.
1. Example of Business Model
2. Embodiment
3. Modification
4. Others

### 1. Example of Business Model

First, an example of a business model to which the present technology is applied will be described.

At the time of filing the present technology, EVs tend to be priced higher than engine-powered vehicles of the same class due to the high cost of EV batteries. Since fees for leasing, renting, or the like for EVs are also set based on the price of the EVs, the fees tend to be higher than fees for leasing, renting, or the like of engine-powered vehicles of the same class. Thus, when purchasing, leasing, or renting an EV, the user's burden is expected to be larger compared to purchasing, leasing, or renting an engine-powered vehicle of the same class.

On the other hand, compared to a vehicle body, an EV battery deteriorates at a lower speed when the battery control is appropriately performed, and its monetary value decreases more gradually. For example, the monetary value of the vehicle body of an EV significantly decreases when its service life (for example, about 10 years) has elapsed. On the other hand, an EV battery can be, for example, reused, repurposed, or recycled even after the vehicle body has reached the end of its service life. For example, an EV battery can be used (repurposed) by changing its purpose to a stationary battery or the like after an EV has been scrapped. Thus, it is expected that the monetary value of an EV battery remains to some extent even after the vehicle body has reached the end of its service life.

Taking the above into consideration, in the business model to which the present technology is applied, when the user purchases an EV, a battery operator bears at least part of the cost of the EV battery. This reduces the financial burden required for the user to purchase an EV.

In contrast, the battery operator acquires at least part of rights related to the EV battery. In addition, the battery operator can obtain revenue by using the battery within the scope of the acquired right. This enables the battery operator to obtain revenue exceeding the cost borne by the battery operator (hereinafter referred to as a burden charge), in exchange for bearing at least part of the cost of the EV battery.

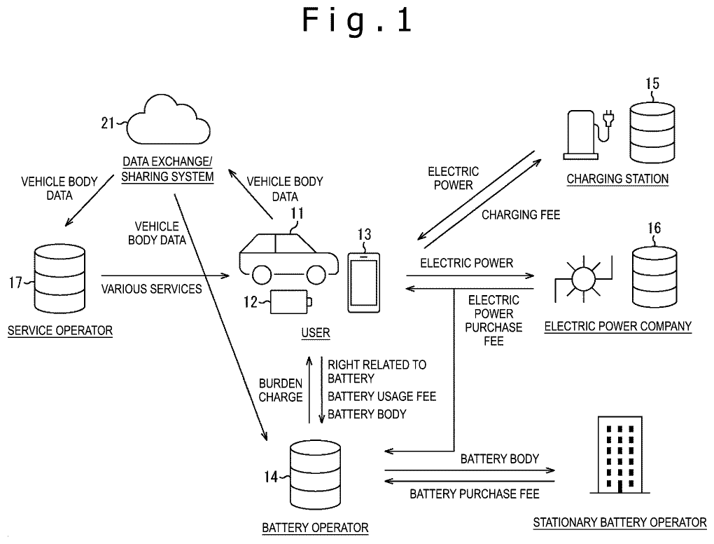

Here, an overview of a business model to which the present technology is applied will be described with reference to FIG. 1.

Hereinafter, unless otherwise specified, the user refers to an owner of a vehicle 11.

For example, the user owns the vehicle 11 and an information processing terminal 13.

The vehicle 11 is an EV that travels using electric power of a battery 12.

The information processing terminal 13 is constituted by, for example, a smartphone, a tablet terminal, or a personal computer (PC). For example, the user can acquire information regarding the vehicle 11 or provide the information to the outside using the information processing terminal 13. In addition, for example, the user can use a predetermined application (hereinafter, referred to as a battery operation APP) provided by the battery operator, by using the information processing terminal 13. The user can also use the battery operation APP in the vehicle 11.

The battery operator bears at least part of the cost of the battery 12 when the user purchases the vehicle 11. The battery operator may pay the burden charge for the battery 12 to the user or to a supplier of the vehicle 11, for example.

In contrast, the battery operator acquires at least part of the rights related to the battery 12. Specifically, the battery operator acquires, as the rights related to the battery 12, at least a right to acquire a battery usage fee and a right to retrieve a battery.

The right to acquire a battery usage fee is a right to acquire a usage fee for the battery 12 under a pay-per-use system. The usage fee for the battery 12 is calculated based on, for example, a usage amount of the battery 12. More specifically, the usage fee for the battery 12 is calculated based on, for example, the charge amount or the discharge amount of the battery 12.

The right to retrieve the battery is a right to acquire the battery 12 after use after the use of the battery 12 in the vehicle 11 is stopped due to scrapping of the vehicle or the like. At this time, for example, in a case where the battery operator does not have an ownership of the battery 12 before the vehicle is scrapped, or has only a part of the ownership of the battery 12, the entire ownership of the battery 12 is transferred to the battery operator after the vehicle is scrapped.

Then, after the battery operator retrieves the battery 12 after use, the battery operator can obtain revenue by, for example, reusing, repurposing, or recycling the battery 12. Repurposing refers, for example, to using the battery 12 as it is for other applications, such as a stationary storage battery. Reusing refers, for example, to disassembling the battery 12, selecting cells, and reusing the selected cells in another battery. Recycling refers, for example, to disassembling the battery 12 down to the material level and using it for production of new batteries. For example, the battery operator can obtain a battery purchase fee from a stationary battery operator by selling the battery 12 to the stationary battery operator. In contrast, the battery 12 is repurposed as a stationary battery and is effectively utilized without being discarded.

The battery 12 after use may be directly supplied from the user to a reuse destination, a repurpose destination, or a reuse destination without going through the battery operator. Further, the battery operator can obtain the battery purchase fee from, for example, the reuse destination, the repurpose destination, or the reuse destination.

The battery operator may further acquire, for example, at least part of the ownership of the battery 12, a profit acquisition right, and a data acquisition right.

The profit acquisition right is, for example, a right to acquire at least part of a profit that is acquired by using the battery 12 while the user owns the battery 12. For example, when the user supplies (sells) electric power to an electric power company through a virtual power plant (VPP), the battery operator can acquire at least part of the electric power purchase fee from the electric power company. In this case, the user and the battery operator may share the electric power purchase fee, or the battery operator may acquire all the electric power purchase fee.

The data acquisition right is a right to acquire, for example, at least part of data related to the battery 12 (hereinafter referred to as battery data). The battery data is, for example, data indicating a usage status of the battery 12. The usage status of the battery 12 includes at least one of, for example, use date and time, a discharge amount, charging date and time, a charge amount, a state of charge (SOC), and a deteriorated state (for example, state of health (SOH)) of the battery 12.

For example, the vehicle 11 uploads vehicle body data including the battery data to a data exchange/sharing system 21. The vehicle body data includes, for example, data indicating a usage status of the vehicle 11, in addition to the battery data described above. The usage status of the vehicle 11 includes, for example, data such as a travel place, a travel date and time, and a travel speed.

For example, a server (hereinafter referred to as a battery operation server) 14 owned by the battery operator can download data, which is at least part of the vehicle body data and including the battery data, from the data exchange/sharing system 21.

The data exchange/sharing system 21 is a system that includes, for example, a communication network, a server, and the like, and exchanges and shares various data in the automobile industry such as CATENA-X and mobility open blockchain initiative (MOBI).

The data exchange/sharing system 21 supplies, for example, at least part of the vehicle body data acquired from each vehicle 11 to a server (hereinafter referred to as a service providing server) 18 of a service operator. The service operator (service providing server 17) provides various services based on, for example, the vehicle body data from each vehicle 11. For example, the service providing server 17 provides a service such as provision of an advertisement or information on the surroundings of the vehicle 11 to the vehicle 11 or the information processing terminal 13.

For example, the battery operation server 14 may acquire the vehicle body data including the battery data from the vehicle 11 or the information processing terminal 13 via a communication network or the like.

The right related to the battery 12 described above is an example, and the type and content of the right may be changed as necessary.

As described above, the user can reduce the cost for purchasing the vehicle 11 by having the battery operator bear at least part of the cost for the battery 12 when purchasing the vehicle 11.

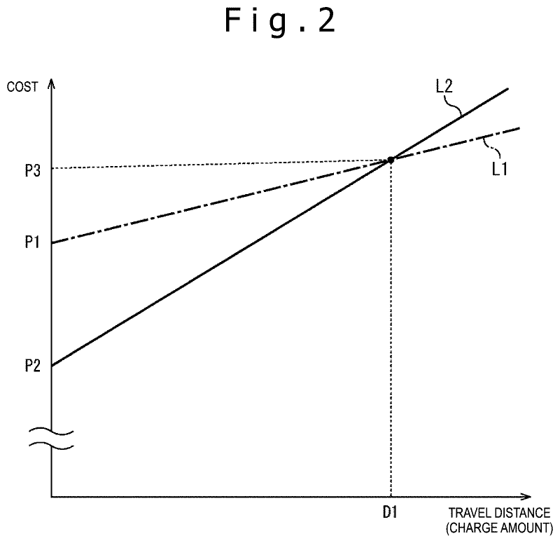

For example, FIG. 2 is a graph schematically showing the cost required when purchasing and using the vehicle 11. The horizontal axis of the graph indicates a travel distance (or a charge amount) of the vehicle 11. The vertical axis of the graph indicates the cost (the purchase cost of the vehicle 11+the running cost).

Here, for the sake of simplicity, the running cost of the vehicle 11 is described by being limited to a charging fee and the battery usage fee.

A line L1 of a dashed-dotted line indicates a transition of the cost borne by the user when the business model described above with reference to FIG. 1 is not used. A line L2 of a solid line indicates a transition of the cost borne by the user when the business model described above with reference to FIG. 1 is used.

For example, when the user does not use the business model described above, the user needs a money amount P1, which is a vehicle body price of the vehicle 11 including the battery 12, as the purchase cost of the vehicle 11. After purchasing the vehicle 11, the user pays the charging fee to a charging station each time the user charges the vehicle 11 at the charging station. That is, the cost for the vehicle 11 is the sum of the money amount P1, which is the purchase cost of the vehicle 11, and the charging fee required according to the travel distance, and transitions as indicated by the line L1.

On the other hand, when the user uses the business model described above, at least part of the cost of the battery 12 is borne by the battery operator, and thus the purchase cost of the vehicle 11 can be suppressed to a money amount P2 which is lower than the money amount P1. After purchasing the vehicle 11, the user pays the charging fee to the charging station each time the user charges the vehicle 11 at the charging station. The user pays the battery usage fee to the battery operator according to the charge amount or the discharge amount of the battery 12. That is, the cost of the vehicle 11 is the sum of the money amount P2, which is the purchase cost of the vehicle 11, and the charging fee and the battery usage fee required according to the travel distance, and transitions as indicated by the line L2.

Then, as shown in FIG. 2, the user can keep the cost of the vehicle 11 low until the travel distance of the vehicle 11 reaches a distance D1.

Thus, by appropriately setting a burden charge (P1-P2) for the battery 12 and the battery usage fee, the user can purchase and use the vehicle 11 at a lower cost than usual.

On the other hand, the battery operator can recover the burden charge of the battery 12 through the battery usage fee. Even when the battery operator cannot recover all the burden charge of the battery 12 through the battery usage fee, the battery operator can recover the burden charge of the battery 12 by selling the battery 12 after use or obtaining a profit from the battery 12 by using the VPP or the like.

### 2. Embodiment

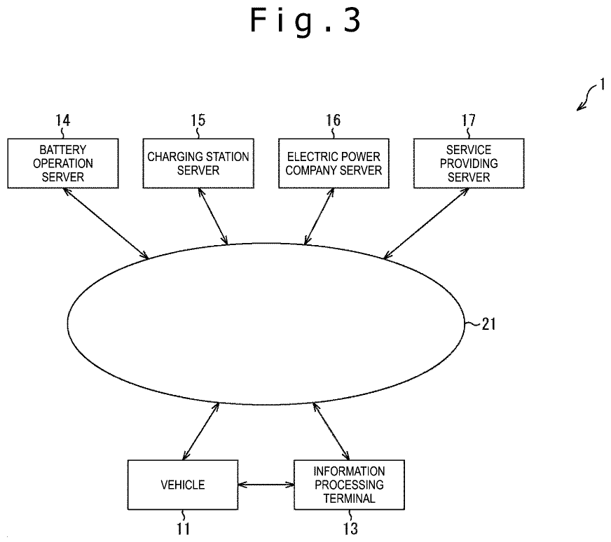

Next, the embodiment of the present technology will be described with reference to FIGS. 3 to 6.

### Configuration Example of Information Processing System 1

FIG. 3 illustrates a configuration example of an information processing system 1 that implements the business model of FIG. 1 by applying the present technology.

The information processing system 1 includes the vehicle 11, the information processing terminal 13, the battery operation server 14, a charging station server 15, an electric power company server 16, and the service providing server 17.

The charging station server 15 is a server owned by the charging station as illustrated in FIG. 1 described above. The electric power company server 16 is a server owned by the electric power company as illustrated in FIG. 1 described above.

The vehicle 11, the information processing terminal 13, the battery operation server 14, the charging station server 15, the electric power company server 16, and the service providing server 17 exchange and share various data via, for example, the data exchange/sharing system 21. The vehicle 11 and the information processing terminal 13 directly communicate with each other to transmit and receive various data.

The vehicle 11, the information processing terminal 13, the battery operation server 14, the charging station server 15, the electric power company server 16, and the service providing server 17 may directly communicate with each other via a communication network such as the Internet without using, for example, the data exchange/sharing system 21.

In addition, although one vehicle 11, one information processing terminal 13, one battery operation server 14, one charging station server 15, one electric power company server 16, one data exchange/sharing system 21, and one service providing server 17 are illustrated in FIG. 3, two or more of each of these components may be provided. For example, although the processing for one vehicle 11 and the battery 12 will be described below, the information processing system 1 actually includes a plurality of the vehicles 11, and the same processing is executed in each vehicle 11.

For example, the vehicle 11 exchanges and shares various data with other devices via the data exchange/sharing system 21. For example, the vehicle 11 generates the vehicle body data including the battery data related to the battery 12, and shares the vehicle body data with the other devices via the data exchange/sharing system 21 or transmits the vehicle body data to the information processing terminal 13. For example, the vehicle 11 uses various services provided by the service providing server 17.

The information processing terminal 13 exchanges and shares various data with the other devices via the data exchange/sharing system 21. For example, the information processing terminal 13 adds data related to the user and the like to the vehicle body data received from the vehicle 11 as necessary, and shares the data with the other devices via the data exchange/sharing system 21. For example, the information processing terminal 13 uses various services provided by the service providing server 17.

The battery operation server 14 exchanges and shares various data with the other devices via the data exchange/sharing system 21. For example, the battery operation server 14 generates billing amount information including information regarding a fee such as the battery usage fee billed to the user, and shares the billing amount information with the other devices via the data exchange/sharing system 21.

The charging station server 15 exchanges and shares various data with the other devices via the data exchange/sharing system 21. For example, the charging station server 15 generates battery charging information regarding charging of the battery 12 of the vehicle 11, and shares the battery charging information with the other devices via the data exchange/sharing system 21. The battery charging information includes, for example, identification information of the charged vehicle 11, and charging date and time, a charge amount, a charging fee, and a charging method (for example, fast-charging or normal charging) of the battery 12.

The electric power company server 16 exchanges and shares various data with the other devices via the data exchange/sharing system 21. For example, the electric power company server 16 generates electric power purchase information regarding the purchase of electric power from the battery 12 or the like of the vehicle 11, and shares the electric power purchase information with the other devices via the data exchange/sharing system 21. The electric power purchase information includes, for example, information regarding purchase date and time, a purchase amount, and a purchase fee of electric power, and a purchase source (for example, a seller or a supplier) of electric power.

The service providing server 17 exchanges and shares various data with the other devices via the data exchange/sharing system 21. For example, the service providing server 17 generates service information for providing various services and shares the service information with the other devices via the data exchange/sharing system 21.

### Configuration Example of Vehicle 11

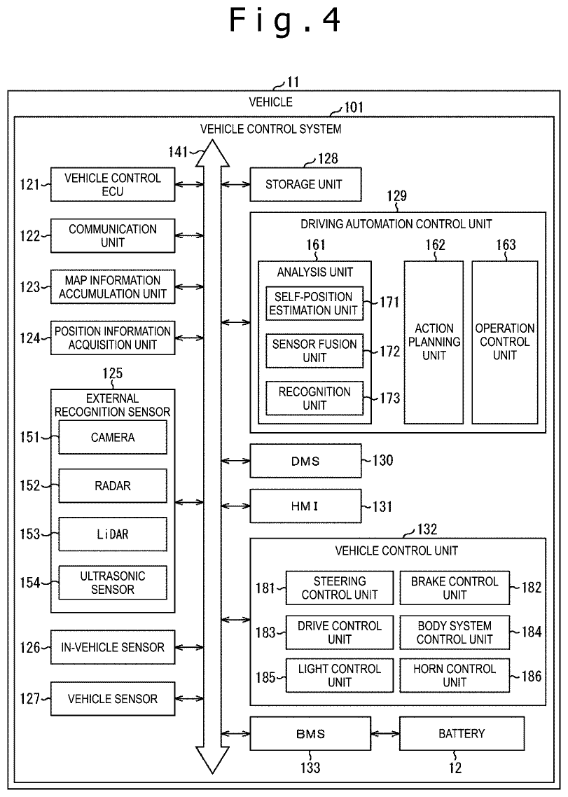

FIG. 4 illustrates a configuration example of the vehicle 11 of the information processing system 1 of FIG. 3.

The vehicle control system 101 is provided in a vehicle 11 and performs processing related to driving automation of the vehicle 11. This driving automation may include driving automation of levels 1 to 5, and may include remote assistance and/or remote driving of the vehicle 11 by a remote driver. The levels of driving automation may refer to the Society of Automotive Engineers (SAE) J3016TM APL2021 Levels of Driving Automation, with SAE Level 0TM referring to the lowest level of driving automation and SAE Level 5TM referring to the highest level of driving automation. For example, SAE Level 1TM driving automation may include driver support features that provide steering or brake/acceleration support to a driver, and SAE Level 5TM driving automation may include automated driving features that can drive the vehicle under all conditions.

The vehicle control system 101 includes a vehicle control electronic control unit (ECU) 121, a communication unit 122, a map information accumulation unit 123, a position information acquisition unit 124, an external recognition sensor 125, an in-vehicle sensor 126, a vehicle sensor 127, a storage unit 128, a driving automation control unit 129, a driver monitoring system (DMS) 130, a human machine interface (HMI) 131, a vehicle control unit 132, and a battery management system (BMS) 133.

Two or more (or, in some cases, all) of the vehicle control ECU 121, the communication unit 122, the map information accumulation unit 123, the position information acquisition unit 124, the external recognition sensor 125, the in-vehicle sensor 126, the vehicle sensor 127, the storage unit 128, the driving automation control unit 129, the DMS 130, the HMI 131, and the vehicle control unit 132 may be communicably connected to each other via a communication network 141. The communication network 141 may include, for example, an in-vehicle communication network, a bus, and/or the like compliant with a digital bidirectional communication standard such as a controller area network (CAN), a local interconnect network (LIN), a local area network (LAN), FlexRay®, or Ethernet®. In some embodiments, the communication network 141 may include two or more types of communication networks, and different types of communication networks may be selectively used depending on the type of data to be transmitted. For example, the CAN may be used for data related to vehicle control, and the Ethernet may be used for large-volume data. In some embodiments, two or more (or, in some cases, all) units of the vehicle control system 101 may be connected not via the communication network 141 but directly via wireless communication (e.g., for communication at a relatively short distance). In some embodiments, the wireless communication may use a short-range wireless communication technology. Non-limiting examples of short-range wireless communication technologies include near-field communication (NFC) and Bluetooth®. In some embodiments, two or more (or, in some cases, all) units of the vehicle control system 101 may be connected via the communication network 141 and via a wireless communication technology (e.g., a short-range wireless communication technology).

Hereinafter, in embodiments where two or more units of the vehicle control system 101 communicate with each other via the communication network 141, the communication network 141 will not be described. For example, in an embodiment where the vehicle control ECU 121 and the communication unit 122 communicate with each other via the communication network 141, it is simply described that the vehicle control ECU 121 and the communication unit 122 communicate with each other.

The vehicle control ECU 121 may be implemented by, for example, various processors, such as a central processing unit (CPU) and/or a microprocessing unit (MPU). The vehicle control ECU 121 controls all or a part of the functions of the vehicle control system 101.

The communication unit 122 communicates with various devices inside the vehicle 11 (hereinafter referred to as in-vehicle devices), various devices outside the vehicle 11 (hereinafter referred to as external devices), other vehicles, base stations, and/or the like, to transmit and receive various types of data. In some embodiments, the communication unit 122 may communicate using a plurality of communication technologies.

Non-limiting examples of communication between the communication unit 122 and one or more external devices will be schematically described. In some embodiments, the communication unit 122 communicates with a server or the like existing on an external network (hereinafter referred to as an external server) via a base station or an access point by a wireless communication technology. Examples of wireless communication technologies include, but are not limited to, 5th generation mobile communication system (5G), long term evolution (LTE), dedicated short range communications (DSRC), and the like. The external network with which the communication unit 122 can communicates may be, for example, the Internet, a cloud network, a company-specific network, or the like. The communication technology used by the communication unit 122 to communicate with the external network is not particularly limited as long as it is a wireless communication technology that enables digital bidirectional communication at a communication speed equal to or more than a predetermined speed and at a distance equal to or more than a predetermined distance.

In some embodiments, the communication unit 122 may communicate with terminals existing in the vicinity of the vehicle 11 using a peer-to-peer (P2P) technology. The terminals existing in the vicinity of the vehicle 11 may include, for example, a terminal worn by a body moving at a relatively low speed, such as a pedestrian or a bicycle, a terminal installed at a fixed position in a store or the like, and/or a machine type communication (MTC) terminal. In some embodiments, the communication unit 122 may perform vehicle-to-everything (V2X) communication. V2X communication generally refers to communication between a vehicle 11 and another entity. Non-limiting examples of V2X communication include vehicle-to-vehicle communication with another vehicle, vehicle-to-infrastructure communication with a roadside device or the like, vehicle-to-home communication with a home, and vehicle-to-pedestrian communication with a terminal or the like carried or worn by a pedestrian.

In some embodiments, the communication unit 122 may receive a program for updating software for controlling the operation of the vehicle control system 101 from outside the vehicle 11 (e.g., over the air). In some embodiments, the communication unit 122 may receive map information, traffic information, information around the vehicle 11, and/or the like from outside the vehicle 11. In some embodiments, the communication unit 122 may transmit information regarding the vehicle 11, information around the vehicle 11, and/or the like to external devices or external networks. Examples of the information regarding the vehicle 11 that may be transmitted to external devices or external networks by the communication unit 122 include, but are not limited to, data indicating the state of the vehicle 11, a recognition result by a recognition unit 173, and the like. In some embodiments, the communication unit 122 may communicate with a vehicle emergency call system. A non-limiting example of a vehicle emergency call system is eCall.

In some embodiments, the communication unit 122 may receive an electromagnetic wave transmitted by a road traffic information communication system. In some embodiments, the electromagnetic wave may be transmitted using a radio wave beacon, an optical beacon, and/or FM multiplex broadcasting.

Non-limiting examples of communication between the communication unit 122 and one or more in-vehicle devices will be schematically described. In some embodiments, the communication unit 122 may communicate with one or more in-vehicle devices using wireless communication. For example, in some embodiments, the communication unit 122 may wirelessly communicate with an in-vehicle device by any wireless communication technology that enables digital bidirectional communication at a communication speed equal to or more than a predetermined speed. Non-limiting examples of wireless communication technologies include wireless LAN, Bluetooth, NFC, and wireless USB (WUSB). The communication unit 122 is not limited thereto, and the communication unit 122 may communicate with one or more in-vehicle devices using wired communication (in addition, or as an alternative, to wireless communication). For example, in some embodiments, the communication unit 122 may communicate with one or more in-vehicle devices by wired communication via a cable connected to a connection terminal (not illustrated). In some embodiments, the communication unit 122 may communicate with one or more in-vehicle devices by any wired communication technology that enables digital bidirectional communication at a communication speed equal to or more than a predetermined speed. Non-limiting examples of wired communication technologies include universal serial bus (USB), high-definition multimedia interface (HDMI)®, and mobile high-definition link (MHL).

Here, the in-vehicle devices refer to, for example, devices that are not connected to the communication network 141 in the vehicle 11. The in-vehicle devices are divided into devices that contain the vehicle control system 101 and devices that do not. Examples of in-vehicle devices that do not contain the vehicle control system 101 include, but are not limited to, a mobile device or a wearable device carried by a user in the vehicle 11 (e.g., a driver, a passenger), an information device temporarily installed in the vehicle 11, and the like. These devices may, for example, be moved outside the vehicle 11 and become external devices.

The map information accumulation unit 123 accumulates a map acquired from external devices or external networks and/or a map created by the vehicle 11. For example, the map information accumulation unit 123 may accumulate a three-dimensional high-precision map, a global map having lower precision than the high-precision map and covering a wide area, and/or the like.

The high-precision map may be, for example, a dynamic map, a point cloud map, a vector map, or the like. The dynamic map may be, for example, a map including four layers of dynamic information, semi-dynamic information, semi-static information, and static information, and may be provided to the vehicle 11 from an external server or the like. The point cloud map may be a map including a point cloud (point group data). The vector map may be, for example, a map in which traffic information such as positions of lanes and/or traffic lights is associated with a point cloud map, for adaptation to driving automation.

The point cloud map and the vector map may be, for example, provided from an external server or the like, or may be created by the vehicle 11 as a map to be matched with a local map to be described later based on sensing results by a camera 151, a radar 152, a LiDAR 153, and the like, and may be accumulated in the map information accumulation unit 123. Furthermore, in a case where a high-precision map is provided from an external server or the like, for example, map data of several hundred square meters regarding a planned path on which the vehicle 11 travels may be acquired from the external server or the like in order to reduce the amount of communication.

The position information acquisition unit 124 acquires position information of the vehicle 11. The acquired position information may be supplied to the driving automation control unit 129. In some embodiments, the position information acquisition unit 124 may receive a global navigation satellite system (GNSS) signal from a GNSS satellite. In some embodiments, the position information acquisition unit 124 may receive a signal from a beacon or the like.

The external recognition sensor 125 includes various sensors used for recognizing a situation outside the vehicle 11, and supplies sensor data from one or more (or, in some cases, all) sensors to one or more (or, in some cases, all) units of the vehicle control system 101. The external recognition sensor 125 may include any type and any number of sensors.

In some embodiments, the external recognition sensor 125 may include the camera 151, the radar 152, the Light Detection and Ranging/Laser Imaging Detection and Ranging (LiDAR) 153, and an ultrasonic sensor 154. The external recognition sensor 125 is not limited thereto, and the external recognition sensor 125 may include one or more types of sensors among the camera 151, the radar 152, the LiDAR 153, and the ultrasonic sensor 154. The numbers of the cameras 151, the radars 152, the LiDAR 153, and the ultrasonic sensors 154 are not particularly limited as long as they can be practically installed in the vehicle 11. Furthermore, the type of sensor included in the external recognition sensor 125 is not limited to this example, and the external recognition sensor 125 may include another type of sensor. An example of the sensing area of each sensor included in the external recognition sensor 125 will be described later.

The camera 151 may use any suitable imaging method. In some embodiments, the camera 151 may use an imaging method capable of distance measurement. Non-limiting examples of cameras using imaging methods capable of distance measurement include a time of flight (ToF) camera, a stereo camera, a monocular camera, and an infrared camera. The camera 151 is not limited thereto and may be a camera for simply acquiring a captured image regardless of distance measurement.

In some embodiments, the external recognition sensor 125 may include an environment sensor for detecting one or more characteristics of the environment surrounding the vehicle 11. Non-limiting examples of characteristics of the environment that may be detected include weather, meteorological phenomenon, brightness, and the like. In some embodiments, the environment sensor includes various sensors, such as a rain drop sensor, a fog sensor, a sunshine sensor, a snow sensor, and/or an illuminance sensor.

In some embodiments, the external recognition sensor 125 may include a microphone used for detecting sound around the vehicle 11, a position of a sound source, and/or the like.

The in-vehicle sensor 126 includes various sensors for detecting information inside the vehicle 11, and supplies sensor data from one or more (or, in some cases, all) of the various sensors to one or more (or, in some cases, all) units of the vehicle control system 101. The type and number of the various sensors included in the in-vehicle sensor 126 are not particularly limited as long as the types and numbers allow practical installation of the sensors in the vehicle 11.

In some embodiments, the in-vehicle sensor 126 may include one or more of a camera, a radar, a seating sensor, a microphone, and a biological sensor. In some embodiments, the camera included in the in-vehicle sensor 126 may use an imaging method capable of measuring a distance. Non-limiting examples of cameras using imaging methods capable of measuring a distance include a ToF camera, a stereo camera, a monocular camera, and an infrared camera. The camera included in the in-vehicle sensor 126 is not limited thereto, and the camera may be a camera for simply acquiring a captured image regardless of distance measurement. The biological sensor included in the in-vehicle sensor 126 may be provided, for example, in a seat, a steering wheel, or the like, and may detect various types of biological information of a user.

The vehicle sensor 127 includes various sensors for detecting the state of the vehicle 11, and supplies sensor data from one or more (or, in some cases, all) of the various sensors to one or more (or, in some cases, all) units of the vehicle control system 101. The type and number of the various sensors included in the vehicle sensor 127 are not particularly limited as long as the types and numbers allow practical installation of the sensors in the vehicle 11.

In some embodiments, the vehicle sensor 127 may include a speed sensor, an acceleration sensor, an angular velocity sensor (gyro sensor), and/or an inertial measurement unit (IMU) integrating these sensors. In some embodiments, the vehicle sensor 127 may include a steering angle sensor that detects a steering angle of a steering wheel, a yaw rate sensor, an accelerator sensor that detects an operation amount (e.g., pedal force, pedal stroke) of an accelerator pedal, and/or a brake sensor that detects an operation amount (e.g., pedal force, pedal stroke) of a brake pedal. In some embodiments, the vehicle sensor 127 may include a rotation sensor that detects the rotation speed of an engine or a motor, an air pressure sensor that detects the air pressure of a tire, a slip rate sensor that detects the slip rate of a tire, and/or a wheel speed sensor that detects the rotation speed of a wheel. In some embodiments, the vehicle sensor 127 may include a battery sensor that detects a remaining amount and a temperature of a battery, and/or an impact sensor that can detect an external impact.

The storage unit 128 includes at least one of a nonvolatile storage medium and a volatile storage medium, and stores data and a program. Non-limiting examples of the storage medium include a magnetic storage device, a semiconductor storage device, an optical storage device, and a magneto-optical storage device such as an electrically erasable programmable read-only memory (EEPROM), a random access memory (RAM), and/or a hard disc drive (HDD). The storage unit 128 stores various programs and data used by one or more (or, in some cases, all) units of the vehicle control system 101. In some embodiments, the storage unit 128 includes an event data recorder (EDR) and/or a data storage system for automated driving (DSSAD), and may store information of the vehicle 11 before and after an event such as an accident and/or information acquired by the in-vehicle sensor 126.

The driving automation control unit 129 controls a driving automation function of the vehicle 11. In some embodiments, the driving automation control unit 129 may include an analysis unit 161, an action planning unit 162, and an operation control unit 163.

The analysis unit 161 performs analysis processing of the situation of the vehicle 11 and/or a situation around the vehicle 11. The analysis unit 161 includes a self-position estimation unit 171, a sensor fusion unit 172, and the recognition unit 173.

In some embodiments, the self-position estimation unit 171 may estimate the self-position of the vehicle 11 based on sensor data from the external recognition sensor 125 and a high-precision map accumulated in the map information accumulation unit 123. For example, the self-position estimation unit 171 may estimate the self-position of the vehicle 11 by generating a local map based on sensor data from the external recognition sensor 125 and matching the local map with the high-precision map. As the position of the vehicle 11, for example, the center of the rear wheel pair axle may be used as a reference.

In some embodiments, the local map may be a three-dimensional high-precision map created using a technology such as simultaneous localization and mapping (SLAM), an occupancy grid map, and/or the like. The three-dimensional high-precision map may be, for example, the above-described point cloud map or the like. The occupancy grid map may be a map in which a three-dimensional or two-dimensional space around the vehicle 11 is divided into grids of a predetermined size, and an occupancy state of an object is indicated for each grid. The occupancy state of an object may be indicated by, for example, the presence or absence or a presence probability of the object. In some embodiments, the local map may also be used for, for example, detection processing and/or recognition processing of a situation outside the vehicle 11 by the recognition unit 173.

In some embodiments, the self-position estimation unit 171 may estimate the self-position of the vehicle 11 based on the position information acquired by the position information acquisition unit 124 and/or the sensor data from the vehicle sensor 127.

The sensor fusion unit 172 performs sensor fusion processing of combining a plurality of different types of sensor data (for example, image data supplied from the camera 151 and sensor data supplied from the radar 152) to obtain information. Methods for combining different types of sensor data include, but are not limited to, composite, integration, fusion, association, and the like.

The recognition unit 173 performs detection processing of detecting a situation outside the vehicle 11 and/or recognition processing of recognizing a situation outside the vehicle 11.

For example, the recognition unit 173 may perform detection processing and/or recognition processing of a situation outside the vehicle 11 based on information from the external recognition sensor 125, information from the self-position estimation unit 171, information from the sensor fusion unit 172, and/or the like.

Specifically, for example, the recognition unit 173 may perform detection processing, recognition processing, and/or the like of an object around the vehicle 11. The detection processing of an object may, for example, include detecting the presence or absence, size, shape, position, movement, and/or the like of an object. The recognition processing of an object may, for example, include recognizing an attribute such as a type of an object and/or identifying a specific object. The detection processing and the recognition processing may not necessarily be clearly divided, and may be at least partially duplicative.

In some embodiments, the recognition unit 173 may detect an object around the vehicle 11 by performing clustering to classify a point cloud based on sensor data from the radar 152, the LiDAR 153, and/or the like into clusters of point groups. Therefore, the presence or absence, size, shape, and/or position of an object around the vehicle 11 may be detected.

In some embodiments, the recognition unit 173 may detect the movement of an object around the vehicle 11 by tracking the movement of the clusters of point groups classified by clustering. Therefore, the speed and/or the traveling direction (movement vector) of the object around the vehicle 11 may be detected.

In some embodiments, the recognition unit 173 may detect and/or recognize a vehicle (including a bicycle), a person, an obstacle, a structure, a road, a traffic light, a traffic sign, a road sign, and/or the like based on the image data supplied from the camera 151. In some embodiments, the recognition unit 173 may recognize the type of an object around the vehicle 11 by performing recognition processing such as semantic segmentation.

In some embodiments, the recognition unit 173 may perform recognition processing of traffic rules around the vehicle 11 based on a map accumulated in the map information accumulation unit 123, an estimation result of the self-position by the self-position estimation unit 171, and/or a recognition result of an object around the vehicle 11 by the recognition unit 173. Through this processing, the recognition unit 173 may recognize the position and/or the state of a traffic light, the contents of a traffic sign and/or a road sign, the contents of a traffic regulation, a travelable lane, and/or the like.

In some embodiments, the recognition unit 173 may perform recognition processing of the environment around the vehicle 11. In some embodiments, the recognition unit 173 may recognize one or more characteristics of the weather (e.g., temperature, humidity, brightness), the state of the road surface, and/or the like.

The action planning unit 162 creates an action plan of the vehicle 11. For example, the action planning unit 162 may create an action plan by performing path planning and path following.

In some embodiments, the path planning may include global path planning and local path planning. The global path planning may include planning a rough path from the start to the goal. The local path planning, which is also referred to as trajectory planning, may include generating a trajectory in the vicinity of the vehicle 11 through which the vehicle 11 can safely and smoothly travel along the planned path given the motion characteristics of the vehicle 11, the presence of any obstacles, and the like.

In some embodiments, the path following may include planning an operation for safe and accurate traveling on a path planned by the path planning within a planned time. For example, the action planning unit 162 may calculate a target speed and/or a target angular velocity of the vehicle 11 based on a result of the path following processing.

The operation control unit 163 controls the operation of the vehicle 11 in order to achieve the action plan created by the action planning unit 162.

For example, in some embodiments, the operation control unit 163 may control a steering control unit 181, a brake control unit 182, and/or a drive control unit 183 included in the vehicle control unit 132 to be described later to perform lateral vehicle motion control and/or longitudinal vehicle motion control such that the vehicle 11 travels on the trajectory calculated by the trajectory planning. For example, the operation control unit 163 may perform control (e.g., lateral vehicle motion control, longitudinal vehicle motion control) for the purpose of one or more driver assistance functions and/or driving automation. Non-limiting examples of driver assistance functions include collision avoidance or impact mitigation, inter-vehicle distance control (e.g., maintenance of a specified distance from a vehicle traveling in front of the vehicle 11), vehicle speed control (e.g., maintenance of a specified speed), vehicle collision warning, and lane departure warning. A non-limiting example of driving automation includes traveling without operation of a driver or a remote driver.

In some embodiments, the DMS 130 may perform authentication processing of the driver, recognition processing of the state of the driver, and/or the like based on sensor data from the in-vehicle sensor 126, input data input to the HMI 131 to be described later, and/or the like. Non-limiting examples of characteristics of the state of the driver that may be recognized include physical condition, arousal level, concentration level, fatigue level, line-of-sight direction, drunkenness level, driving operation, posture, and the like.

In some embodiments, the DMS 130 may perform authentication processing of a user other than the driver (e.g., a passenger) and/or recognition processing of the state of the user. In some embodiments, the DMS 130 may perform recognition processing of a situation inside the vehicle 11 based on sensor data from the in-vehicle sensor 126. Non-limiting examples of characteristics of the situation inside the vehicle 11 that may be recognized include temperature, humidity, brightness, odor, and the like.

The HMI 131 receives various types of data, instructions, and the like as input and presents various types of data to a user.

Data input to the HMI 131 will be schematically described. The HMI 131 includes an input device used by a person to input data, an instruction, and/or the like. The HMI 131 generates an input signal based on the data, instruction, and/or the like input by the input device, and supplies the input signal to one or more (or, in some cases, all) units of the vehicle control system 101. In some embodiments, the HMI 131 may include a touch panel, a button, a switch, and/or a lever as the input device. The HMI 131 is not limited thereto and may include an input device that enables inputting information by a method other than manual operation, such as voice, gesture, and/or the like. In some embodiments, the HMI 131 may include a remote control device using infrared rays and/or radio waves and/or an external connection device adaptive to the operation of the vehicle control system 101, as an input device. Non-limiting examples of the external connection device include a mobile device (e.g., a smartphone) and a wearable device (e.g., a smartwatch).

Presentation of data by the HMI 131 will be schematically described. The HMI 131 generates visual information, auditory information, and/or tactile information for the user and/or one or more people outside of the vehicle 11. Furthermore, the HMI 131 may perform output control for controlling output, output content, output timing, output method, and/or the like for each piece of generated information. Examples of visual information that may be generated and outputted by the HMI 131 include, but are not limited to, an operation screen, a state display of the vehicle 11, a warning display, an image such as a monitor image indicating a situation around the vehicle 11, and information indicated by light. Examples of auditory information that may be generated and outputted by the HMI 131 include, but are not limited to, voice guidance, a warning sound, a warning message, and the like. Examples of tactile information that may be generated and outputted by the HMI 131 include, but are not limited to, information given to the tactile sense of a user by force, vibration, movement, and/or the like.

In some embodiments, an output device to which the HMI 131 may output visual information may include a display device that presents the visual information by displaying an image by itself and/or a projector device that presents visual information by projecting an image. In some embodiments, the display device may include a device that displays visual information in the field of view of a user, such as a head-up display, a transmissive display, or a wearable device having an augmented reality (AR) function, in addition or as an alternative to a typical display. In some embodiments, an output device to which the HMI 131 may output visual information may include a display device included in a navigation device, an instrument panel, a camera monitoring system (CMS), an electronic mirror, a lamp, and/or the like provided in the vehicle 11.

In some embodiments, an output device to which the HMI 131 may output auditory information may include an audio speaker, a headphone, and/or an earphone.

In some embodiments, an output device to which the HMI 131 may output tactile information may include a haptic element using a haptic technology. The haptic element may be provided, for example, in a portion of the vehicle 11 with which the user is in contact, such as a steering wheel or a seat.

The vehicle control unit 132 controls one or more (or, in some cases, all) units of the vehicle 11. The vehicle control unit 132 includes the steering control unit 181, the brake control unit 182, the drive control unit 183, a body system control unit 184, a light control unit 185, and a horn control unit 186.

The steering control unit 181 performs detection, control, and/or the like of the state of the steering system of the vehicle 11. The steering system includes, for example, a steering mechanism including a steering wheel and the like, an electric power steering, and/or the like. The steering control unit 181 includes, for example, a steering ECU that controls the steering system, an actuator that drives the steering system, and/or the like.

The brake control unit 182 performs detection, control, and/or the like of the state of the brake system of the vehicle 11. The brake system includes, for example, a brake mechanism including a brake pedal and the like, an antilock brake system (ABS), a regenerative brake mechanism, and/or the like. The brake control unit 182 includes, for example, a brake ECU that controls the brake system, an actuator that drives the brake system, and/or the like.

The drive control unit 183 performs detection, control, and/or the like of the state of the drive system of the vehicle 11. The drive system includes, for example, an accelerator pedal, a driving force generation device for generating driving force for an internal combustion engine, a driving motor, or the like, a driving force transmission mechanism for transmitting the driving force to wheels, and/or the like. The drive control unit 183 includes, for example, a drive ECU that controls the drive system, an actuator that drives the drive system, and/or the like.

The body system control unit 184 performs detection, control, and/or the like of the state of the body system of the vehicle 11. The body system includes, for example, a keyless entry system, a smart key system, a power window device, a power seat, an air conditioner, an airbag, a seat belt, a shift lever, and/or the like. The body system control unit 184 includes, for example, a body system ECU that controls the body system, an actuator that drives the body system, and/or the like.

The light control unit 185 performs detection, control, and/or the like of the states of various lights of the vehicle 11. Non-limiting examples of lights that may be controlled by the light control unit 185 include a headlight, a backlight, a fog light, a turn signal, a brake light, a projector light, a display of a bumper, and the like. The light control unit 185 includes a light ECU that controls a light, an actuator that drives the light, and/or the like.

The horn control unit 186 performs detection, control, and/or the like of the state of the car horn of the vehicle 11. The horn control unit 186 includes, for example, a horn ECU that controls the car horn, an actuator that drives the car horn, and/or the like.

The BMS 133 is a system that monitors and controls charging and discharging of the battery 12. The BMS 133 also detects the state of charge (SOC) and the deteriorated state (for example, SOH) of the battery 12.

### Configuration Example of Battery Operation Server 14

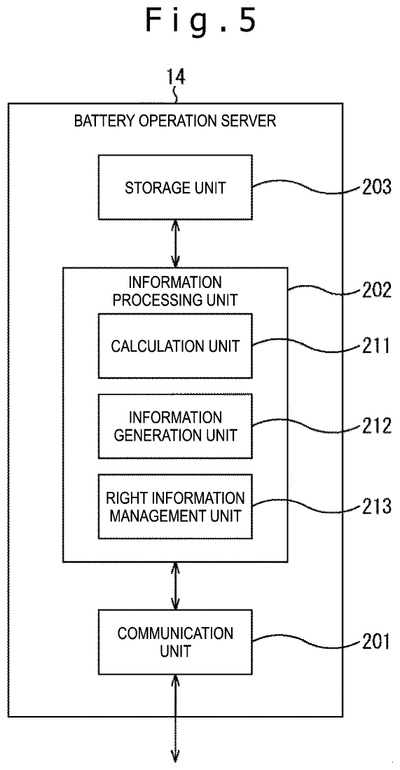

FIG. 5 illustrates a configuration example of a function of the battery operation server 14 of the information processing system 1 of FIG. 3.

The battery operation server 14 includes a communication unit 201, an information processing unit 202, and a storage unit 203.

The communication unit 201 exchanges and shares various data with the other devices via the data exchange/sharing system 21.

The information processing unit 202 executes control of the battery operation server 14 and various information processing. The information processing unit 202 includes a calculation unit 211, an information generation unit 212, and a right information management unit 213.

The calculation unit 211 calculates the usage fee (battery usage fee) for the battery 12 of the vehicle 11 based on data received from other devices and the like. The calculation unit 211 calculates a billing amount to be billed to the user based on the battery usage fee, data received from the other devices, and the like.

The information generation unit 212 generates various information for notification to the outside (for example, a user or the like). For example, the information generation unit 212 generates the billing amount information including information regarding the battery usage fee and information regarding the billing amount. The information generation unit 212 notifies the outside of various information such as the billing amount information by exchanging or sharing various information via the communication unit 201 and the data exchange/sharing system 21.

The right information management unit 213 manages information regarding a right related to the battery 12 of the vehicle 11 (hereinafter referred to as battery right information). For example, the right information management unit 213 generates the battery right information, stores the battery right information in the storage unit 203, and updates the battery right information as necessary.

The battery right information includes, for example, contract information including the content of the right related to the battery 12, and information regarding the vehicle 11, the battery 12, and a debtor (for example, a user) that are subjected to the contract.

### Billing Amount Notification Processing

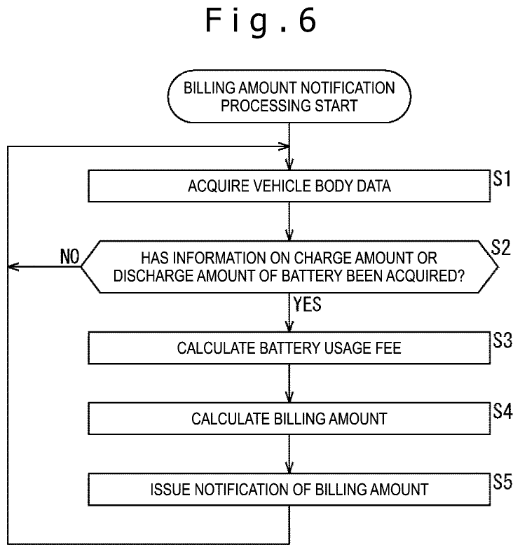

Next, billing amount notification processing executed by the battery operation server 14 will be described with reference to the flowchart of FIG. 6.

In step S1, the information processing unit 202 acquires the vehicle body data. For example, the information processing unit 202 receives the vehicle body data of the vehicle 11, which is a target for charging the battery usage fee or the like, via the data exchange/sharing system 21 and the communication unit 201.

In step S2, the calculation unit 211 determines whether data related to the charge amount or the discharge amount of the battery 12 has been acquired. For example, when the vehicle body data acquired in the processing of step S1 does not include the data related to the charge amount or the discharge amount of the battery 12, the calculation unit 211 determines that the data related to the charge amount or the discharge amount of the battery 12 has not been acquired, and the processing returns to step S1.

Thereafter, in step S2, processing operations of step S1 and step S2 are repeatedly executed until it is determined that the data related to the charge amount or the discharge amount of the battery 12 has been acquired.

On the other hand, in step S2, when the vehicle body data acquired in the processing of step S1 includes the data related to the charge amount or the discharge amount of the battery 12, the calculation unit 211 determines that the data related to the charge amount or the discharge amount of the battery 12 has been acquired, and the processing proceeds to step S3.

In step S3, the calculation unit 211 calculates the battery usage fee.

For example, when calculating the battery usage fee based on the charge amount of the battery 12, the calculation unit 211 calculates the charge amount of the battery 12 since the previous calculation of the battery usage fee. For example, when the battery 12 has been charged a plurality of times since the previous calculation of the battery usage fee, the calculation unit 211 sums the amount charged over the plurality of times. For example, the calculation unit 211 calculates the battery usage fee by a predetermined calculation formula based on the calculated charge amount.

For example, when calculating the battery usage fee based on the discharge amount of the battery 12, the calculation unit 211 calculates the discharge amount of the battery 12 since the previous calculation of the battery usage fee. For example, when the battery 12 is charged one or more times since the previous calculation of the battery usage fee, the calculation unit 211 calculates the discharge amount, while taking into account the increase in the capacity of the battery 12 due to charging. For example, the calculation unit 211 calculates the battery usage fee by a predetermined calculation formula based on the calculated discharge amount.

The calculation unit 211 may calculate the battery usage fee while taking into account, for example, conditions other than the charge amount or the discharge amount of the battery 12.

For example, when calculating the battery usage fee based on the charge amount of the battery 12, the calculation unit 211 may further calculate the battery usage fee based on the charging method of the battery 12. For example, when the battery 12 is fast-charged, deterioration of the battery 12 is accelerated and the monetary value of the battery 12 after use is more likely to decrease compared to when the battery 12 is normally charged. Thus, when the battery 12 is fast-charged, for example, the calculation unit 211 increases the battery usage fee compared to when the battery 12 is normally charged.

A method of acquiring the information regarding the charging method of the battery 12 by the battery operation server 14 is not particularly limited. For example, the vehicle body data supplied from the data exchange/sharing system 21 to the battery operation server 14 may include the information regarding the charging method of the battery 12. For example, the battery operation server 14 may receive the information regarding the charging method of the battery 12 from the vehicle 11, the information processing terminal 13, or the charging station server 15 via the data exchange/sharing system 21.

For example, when calculating the battery usage fee based on the charge amount of the battery 12, the calculation unit 211 may further calculate the battery usage fee based on the charging fee of the battery 12. For example, the calculation unit 211 may increase the battery usage fee as the charging fee of the battery 12 increases, and may decrease the battery usage fee as the charging fee of the battery 12 decreases.

A method of acquiring the information regarding the charging fee of the battery 12 by the battery operation server 14 is not particularly limited. For example, the vehicle body data supplied from the data exchange/sharing system 21 to the battery operation server 14 may include the information regarding the charging fee of the battery 12. For example, the battery operation server 14 may receive the information regarding the charging fee of the battery 12 from the vehicle 11, the information processing terminal 13, or the charging station server 15 via the data exchange/sharing system 21.

For example, the calculation unit 211 may calculate the battery usage fee based on an electric power rate. For example, the calculation unit 211 may increase the battery usage fee as the electric power rate increases, and may decrease the battery usage fee as the electric power rate decreases.

A method of acquiring the information regarding the electric power rate by the battery operation server 14 is not particularly limited. For example, the vehicle body data supplied from the data exchange/sharing system 21 to the battery operation server 14 may include the information regarding the electric power rate. For example, the battery operation server 14 may receive the information regarding the electric power rate from the electric power company server 16 via the data exchange/sharing system 21.

For example, the calculation unit 211 may calculate the battery usage fee based on the monetary value of the battery 12. For example, the calculation unit 211 calculates the monetary value of the battery 12 based on the information regarding a market price of the battery 12 and deterioration information (for example, SOH) of the battery 12. For example, the calculation unit 211 may decrease the battery usage fee as the monetary value of the battery 12 increases, and increase the battery usage fee as the monetary value of the battery 12 decreases. Accordingly, the battery operator can stabilize the profit from the battery business even when the market price of the battery 12 fluctuates due to, for example, technical innovation.

A method of acquiring the information regarding the market price of the battery 12 by the battery operation server 14 is not particularly limited. For example, the battery operator may input information regarding the market price of the battery 12 to the battery operation server 14. For example, the battery operation server 14 may receive information regarding the market price of the battery 12 from the data exchange/sharing system 21.

A method of acquiring the deterioration information of the battery 12 by the battery operation server 14 is not particularly limited. For example, the vehicle body data supplied from the data exchange/sharing system 21 to the battery operation server 14 may include the deterioration information of the battery 12. For example, the battery operation server 14 may receive the deterioration information of the battery 12 from the vehicle 11 or the information processing terminal 13 via the data exchange/sharing system 21.

For example, the calculation unit 211 may calculate the battery usage fee based on the application of the electric power of the battery 12. For example, when the electric power of the battery 12 is used for an ecological application (for example, Vehicle-to-Home (V2H), VPP, and the like), the calculation unit 211 may decrease the battery usage fee compared to when the electric power of the battery 12 is used for movement of the vehicle 11. This promotes the use of the electric power of the battery 12 for the ecological application.

A method of acquiring the information regarding the application of the battery 12 by the battery operation server 14 is not particularly limited. For example, the vehicle body data supplied from the data exchange/sharing system 21 to the battery operation server 14 may include the information regarding the application of the battery 12. For example, the battery operation server 14 may receive information regarding the application of the battery 12 from the vehicle 11 or the information processing terminal 13 via the data exchange/sharing system 21.

For example, the calculation unit 211 may calculate the battery usage fee by combining two or more of the charging method of the battery 12, the charging fee of the battery 12, the electric power rate, the monetary value of the battery 12, and the application of the electric power of the battery 12 with the charge amount or the discharge amount of the battery 12.

In step S4, the calculation unit 211 calculates the billing amount based on the battery usage fee.

For example, when the battery usage fee is billed based on the charge amount each time the battery 12 is charged, the calculation unit 211 sets the battery usage fee as it is as the billing amount.

For example, when the battery usage fee is billed for each predetermined period (for example, for each month), the calculation unit 211 calculates the billing amount by summing the battery usage fees within the period.

For example, the calculation unit 211 may calculate the billing amount by applying various discounts to the battery usage fee.

For example, when the user uses the battery operation APP, the calculation unit 211 may discount the battery usage fee based on service points or the like applied to the user of the battery operation APP.

For example, when the vehicle 11 moves using the battery operation APP, the calculation unit 211 may discount the battery usage fee based on the charge amount or the discharge amount corresponding to the movement.

A method of acquiring the information regarding the usage status of the battery operation APP of the user or the vehicle 11 by the battery operation server 14 is not particularly limited. For example, the battery operation server 14 may receive the information regarding the usage status of the battery operation APP from the vehicle 11 or the information processing terminal 13 via the data exchange/sharing system 21.

For example, the calculation unit 211 may calculate the billing amount by adding at least one of fees the user is scheduled to pay for the battery 12 and revenue the user is scheduled to obtain from the battery 12 to the battery usage fee.

For example, the calculation unit 211 may calculate the billing amount by adding the charging fee of the battery 12 to the battery usage fee. This allows the user to reduce the effort required to pay various fees.

For example, the calculation unit 211 may calculate the billing amount by adding the electric power purchase fee obtained by selling the electric power of the battery 12 to the electric power company by the VPP or the like to the battery usage fee.

A method of acquiring the information regarding the electric power purchase fee by the battery operation server 14 is not particularly limited. For example, the vehicle body data supplied from the data exchange/sharing system 21 to the battery operation server 14 may include the information regarding the electric power purchase fee. For example, the battery operation server 14 may receive the information regarding the electric power purchase fee from the vehicle 11, the information processing terminal 13, or the electric power company server 16 via the data exchange/sharing system 21.

In step S5, the information generation unit 212 issues notification of the billing amount. For example, the information generation unit 212 generates the billing amount information including information regarding the battery usage fee and information regarding the billing amount. The information generation unit 212 transmits the billing amount information to the vehicle 11 or the information processing terminal 13 of the user (for example, the owner of the vehicle 11) who is a target for charging the fee via the communication unit 201 and the data exchange/sharing system 21.

Thereafter, the processing returns to step S1, and processing operations after step S1 are executed.

As described above, a new mechanism regarding a method of bearing the cost of the EV battery is provided. This reduces the financial burden on users for purchasing EVs. In addition, the battery operator can develop a new business model using the EV battery and obtain revenue. Further, effective use of the battery of the EV after use is promoted.

### 3. Modification

Hereinafter, a modification of the embodiment of the present technology described above will be described.

For example, when the vehicle 11 is shared by a plurality of users by rental, lease, car sharing, or the like, the battery usage fee is billed to the users who have used the vehicle 11. That is, for example, the above-described billing amount information is transmitted to the information processing terminal owned by the users who are the user of the vehicle 11.

For example, when the vehicle 11 is transferred to another user by selling or the like, a debtor for the right related to the battery 12 owned by the battery operator is usually a user of a transfer destination of the vehicle 11, although it depends on the contract content. For example, the user of the transfer destination of the vehicle 11 is obligated to pay the battery usage fee or the like to the battery operator. In this case, for example, the right information management unit 213 of the battery operation server 14 updates the right information regarding the battery 12 of the vehicle 11 that has been transferred.

For example, when the information generation unit 212 of the battery operation server 14 detects that the deterioration of the battery 12 exceeds an expected range, based on the deterioration information of the battery 12, the information generation unit 212 may generate information for issuing the notification of the fact and transmit the information to the vehicle 11 or the information processing terminal 13 of the user via the communication unit 201 and the data exchange/sharing system 21. This prompts the user to improve the usage of the battery 12 (vehicle 11). In contrast, when the deterioration state of the battery 12 is not improved, for example, the battery operator may terminate the contract with the user and collect a penalty or the like.

The present technology and the business model to which the present technology is applied can be applied to all mobile bodies on which batteries that supply the electric power for movement are mounted and move by the electric power of the batteries, in addition to the EV. The business model can be applied to, as such a mobile body, for example, an electric two-wheel vehicle such as an electric motorcycle, an electric scooter, and an electric bicycle, an electric airplane, and an electric ship.

### 4. Others

### Configuration Example of Computer

The series of processing steps described above can be executed by hardware or can be executed by software. In a case in which the series of processing steps is executed by software, a program constituting the software is installed on a computer. Herein, a computer includes a computer incorporated in dedicated hardware, a general-purpose personal computer, for example, which can execute various functions by the installation of various programs, and the like.

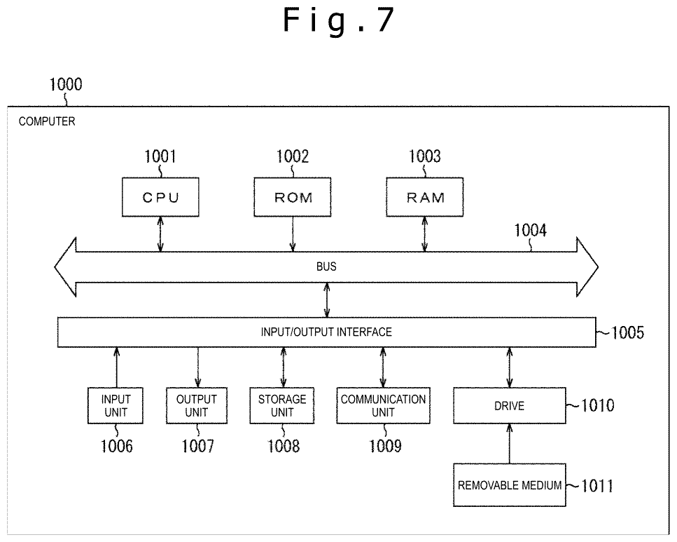

FIG. 7 is a block diagram illustrating a configuration example of hardware of a computer that executes the above-described series of processing steps by a program.

In a computer 1000, a central processing unit (CPU) 1001, a read only memory (ROM) 1002, and a random access memory (RAM) 1003 are connected to one another via a bus 1004.

Furthermore, an input/output interface 1005 is connected to the bus 1004. An input unit 1006, an output unit 1007, a storage unit 1008, a communication unit 1009, and a drive 1010 are connected to the input/output interface 1005.

The input unit 1006 is composed of an input switch, a button, a microphone, an imaging element, and the like. The output unit 1007 is composed of a display, a speaker, and the like. The storage unit 1008 is composed of a hard disk, a nonvolatile memory, and the like. The communication unit 1009 is composed of a network interface and the like. The drive 1010 drives a removable medium 1011 such as a magnetic disk, an optical disk, a magneto-optical disk, or a semiconductor memory.

In the computer 1000 configured as described above, the CPU 1001 loads the program recorded in the storage unit 1008, for example, into the RAM 1003 via the input/output interface 1005 and the bus 1004, and executes the program, thereby performing the above-mentioned series of processing steps.

The program executed by the computer 1000 (CPU 1001) can be provided by being recorded in the removable medium 1011 as a package medium or the like, for example. Further, the program can be provided via a wired or wireless transmission medium such as a local area network, the Internet, or digital satellite broadcasting.

In the computer 1000, the program can be installed in the storage unit 1008 via the input/output interface 1005 by mounting the removable medium 1011 on the drive 1010. The program can also be received by the communication unit 1009 via a wired or wireless transmission medium and installed in the storage unit 1008. Other than the above manners, the program can be pre-installed in the ROM 1002 or the storage unit 1008.

Note that the program executed by the computer may be a program in which processing is performed in time series in the order described in the present specification, or may be a program in which processing is performed in parallel or at a necessary timing such as when a call is performed.

Additionally, in the present specification, a system refers to a collection of a plurality of components (devices, modules (parts), and the like), regardless of whether all of the components are in the same housing. Therefore, the system refers to both a plurality of devices housed in separate housings and connected via a network, and one device in which a plurality of modules are housed in one housing.

Further, the embodiments of the present technology are not limited to the above-described embodiments, and various modifications can be made without departing from the gist of the present technology.

For example, the present technology can have a configuration of cloud computing in which one function is shared and processed in cooperation by a plurality of apparatuses via a network.

Further, each step described in the above-described flowchart can be performed by one apparatus or can be shared and executed by a plurality of apparatuses.

Further, when a single step includes multiple processing operations, the multiple processing operations included in the single step can be executed by a single device, or can be shared and executed by multiple devices.

Combination Example of Configurations

The present technology may also have the following configurations.

### 1

An information processing device including
a calculation unit configured to calculate a battery usage fee that is a usage fee for a battery mounted on a mobile body and configured to supply electric power for movement of the mobile body, based on a charge amount or a discharge amount of the battery, and
an information generation unit that generates billing amount information including information regarding the battery usage fee.

### 2

The Information Processing Device According to (1), wherein
the calculation unit is configured to calculate the battery usage fee further based on at least one of a charging method of the battery, an electric power rate, a charging fee of the battery, an application of electric power of the battery, and a monetary value of the battery.

### 3

The information processing device according to (2), wherein
the calculation unit is configured to increase the battery usage fee when the battery is fast-charged, compared to when the battery is normally charged.

### 4

The information processing device according to (2) or (3), wherein
the calculation unit is configured to decrease the battery usage fee when the electric power of the battery is used for an ecological application compared to when the electric power of the battery is used for movement of the mobile body.

### 5

The information processing device according to any one of (2) to (4), wherein
the calculation unit is configured to calculate a monetary value of the battery based on information regarding a market price of the battery and deterioration information of the battery.

### 6

The information processing device according to any one of (1) to (5), wherein
the calculation unit is configured to calculate a billing amount based on at least one of the battery usage fee, a charging fee of the battery, and revenue obtained by selling electric power of the battery, and
the billing amount information includes information regarding the billing amount.

### 7

The information processing device according to any one of (1) to (6), wherein
the billing amount information includes information regarding the battery usage fee for respective predetermined periods.

### 8

The information processing device according to any one of (1) to (7), further including
a communication unit configured to transmit the billing amount information.

### 9

The information processing device according to (8), wherein
the communication unit is configured to transmit the billing amount information to the mobile body or an information processing terminal of an owner of the mobile body.

### 10

The information processing device according to (8), wherein
the communication unit is configured to transmit the billing amount information to an information processing terminal of a user of the mobile body.

### 11

The information processing device according to any one of (1) to (10), further including
a right information management unit configured to generate and update right information regarding a right related to the battery.

### 12

The information processing device according to any one of (1) to (11), wherein
the information generation unit is configured to generate information for notifying that deterioration of the battery exceeds an expected range when the deterioration of the battery exceeds the expected range.

### 13

The information processing device according to any one of (1) to (12), wherein
the mobile body is an electric vehicle.

### 14

An information processing method including
calculating, by an information processing device, a battery usage fee that is a usage fee for a battery mounted on a mobile body and configured to supply electric power for movement of the mobile body, based on a charge amount or a discharge amount of the battery, and
generating, by the information processing device, billing amount information including information regarding the battery usage fee.

### 15

A program that causes a computer to execute processing, the processing including
calculating a battery usage fee that is a usage fee for a battery mounted on a mobile body and configured to supply electric power for movement of the mobile body, based on a charge amount or a discharge amount of the battery, and
generating billing amount information including information regarding the battery usage fee.

Note that the effects described in the present specification are merely examples, and are not limited, and other effects may be obtained.

### Reference Signs List

1 Information processing system, 11 Vehicle, 12 Battery, 13 Information processing terminal, 14 Battery operation server, 15 Charging station server, 16 Electric power company server, 17 Data exchange/sharing system, 18 Service providing server, 101 Vehicle control system, 132 BMS, 201 Communication unit, 202 Information processing unit, 203 Storage unit, 211 Calculation unit, 212 Information generation unit, 213 Right information management unit

1. An information processing device comprising:
a calculation unit configured to calculate a battery usage fee that is a usage fee for a battery mounted on a mobile body and configured to supply electric power for movement of the mobile body, based on a charge amount or a discharge amount of the battery; and
an information generation unit configured to generate billing amount information including information regarding the battery usage fee.

2. The information processing device according to claim 1, wherein
the calculation unit is configured to calculate the battery usage fee further based on at least one of a charging method of the battery, an electric power rate, a charging fee of the battery, an application of electric power of the battery, and a monetary value of the battery.

3. The information processing device according to claim 2, wherein
the calculation unit is configured to increase the battery usage fee when the battery is fast-charged, compared to when the battery is normally charged.

4. The information processing device according to claim 2, wherein
the calculation unit is configured to decrease the battery usage fee when the electric power of the battery is used for an ecological application compared to when the electric power of the battery is used for movement of the mobile body.

5. The information processing device according to claim 2, wherein
the calculation unit is configured to calculate a monetary value of the battery based on information regarding a market price of the battery and deterioration information of the battery.

6. The information processing device according to claim 1, wherein
the calculation unit is configured to calculate a billing amount based on at least one of the battery usage fee, a charging fee of the battery, and revenue obtained by selling electric power of the battery, and
the billing amount information includes information regarding the billing amount.

7. The information processing device according to claim 1, wherein
the billing amount information includes information regarding the battery usage fee for respective predetermined periods.

8. The information processing device according to claim 1, further comprising
a communication unit configured to transmit the billing amount information.

9. The information processing device according to

8. wherein
the communication unit is configured to transmit the billing amount information to the mobile body or an information processing terminal of an owner of the mobile body.

10. The information processing device according to claim 8, wherein
the communication unit is configured to transmit the billing amount information to an information processing terminal of a user of the mobile body.

11. The information processing device according to claim 1, further comprising:
a right information management unit configured to generate and update right information regarding a right related to the battery.

12. The information processing device according to claim 1, wherein
the information generation unit is configured to generate information for notifying that deterioration of the battery exceeds an expected range when the deterioration of the battery exceeds the expected range.

13. The information processing device according to claim 1, wherein
the mobile body is an electric vehicle.

14. An information processing method comprising:
calculating, by an information processing device, a battery usage fee that is a usage fee for a battery mounted on a mobile body and configured to supply electric power for movement of the mobile body, based on a charge amount or a discharge amount of the battery; and
generating, by the information processing device, billing amount information including information regarding the battery usage fee.

15. A program configured to cause a computer to execute processing, the processing comprising:
calculating a battery usage fee that is a usage fee for a battery mounted on a mobile body and is configured to supply electric power for movement of the mobile body, based on a charge amount or a discharge amount of the battery; and
generating billing amount information including information regarding the battery usage fee.
